(19) United States
(12) Patent Application Publication
(10) Pub. No.: US 2013/0244625 A1
(43) Pub. Date: Sep. 19, 2013

(54) APPARATUS AND METHOD FOR PROVIDING FOR ENABLING USE OF AN APPLICATION BASED ON A DETERMINED OPERATING CONDITION AND SAFETY RATING

(71) Applicants: Jörg Brakensiek, Mountain View, CA (US); Raja Bose, Mountain View, CA (US)

(72) Inventors: Jörg Brakensiek, Mountain View, CA (US); Raja Bose, Mountain View, CA (US)

(73) Assignee: NOKIA CORPORATION, Espoo (FI)

(21) Appl. No.: 13/423,681

(22) Filed: Mar. 19, 2012

(51) Int. Cl. H04W 4/00

(52) U.S. Cl. 455/414.1

(57) ABSTRACT

An apparatus, method, and computer program product are described that provide for an apparatus that can determine the operating condition of a device and a safety rating of an application executed by the device based on the operating condition that is determined. The apparatus may then cause a liability waiver regarding use of the application to be presented to the user for consideration and acceptance based on the safety rating that is determined. If the user accepts the liability waiver, the apparatus may further provide for the storage of an indication of acceptance of the liability waiver and, in turn, enable use of the application. In cases in which the user does not agree to the liability waiver, however, the apparatus may disable at least a portion of the functionality of the application and/or the device.

### TECHNOLOGICAL FIELD

Embodiments of the present invention relate generally to determining an appropriate usage mode of an apparatus based on an operating condition of the apparatus.

### BACKGROUND

Mobile devices, such as cellular telephones and portable digital assistants (PDAs), have become increasingly popular with users and are becoming an essential part of many users' everyday lives. Many users carry their devices with them at all times and interact with their devices several times a day.

Depending on what other activities the user is engaged in, certain interactions or types of interactions may be distracting to the user and may put the user at risk of injury. For example, looking down at the display of a mobile device and typing a text message while driving a vehicle is generally regarded as dangerous behavior, as the user (the driver) is not focusing his attention on the safe operation of the vehicle and could be involved in a car accident, putting himself, his passengers, and others on the road at risk of bodily injury or even death.

Accordingly, it may be desirable to provide an improved mechanism for alerting a user regarding the risks involved with using his or her device under certain operating conditions and allowing certain interactions with a user's device based on the operating condition of the device and the user's assumption of responsibility for the usage.

### BRIEF SUMMARY OF EXAMPLE EMBODIMENTS

Accordingly, embodiments of an apparatus, method, and computer program product are described that can enable use of an application on a device by presenting the user with a liability waiver in certain circumstances based on a determined operating condition and a determined safety rating of the application. In particular, embodiments of an apparatus for enabling use of an application may include at least one processor and at least one memory including computer program code. The at least one memory and the computer program code may be configured to, with the processor, cause the apparatus to determine an operating condition of a device; determine a safety rating of an application executed by the device based on the operating condition determined; provide for presentation to a user of a liability waiver regarding use of the application based on the safety rating determined; and provide for storage of an indication of acceptance of the liability waiver and enable use of the application in an instance in which the indication of acceptance is received. In some cases, the memory and computer program code may be configured to, with the processor, cause the apparatus to disable at least a portion of functionality of the application in an instance in which the indication of acceptance of the liability waiver is absent.

The memory and computer program code may be configured to, with the processor, cause the apparatus to receive user identification information, and the memory and computer program code may further be configured to, with the processor, cause the apparatus to associate the user identification information with a corresponding indication of acceptance of the liability waiver and to provide for storage of the user identification information. Alternatively or additionally, the memory and computer program code may be configured to, with the processor, cause the apparatus to receive information relating to use of the application under the operating condition determined. Similarly, the memory and computer program code may be configured to, with the processor, cause the apparatus to associate the information relating to use of the application with the indication of acceptance of the liability waiver and to store the information relating to use of the application.

In some cases, the memory and computer program code may be configured to, with the processor, cause the apparatus to determine whether an indication of acceptance of the liability waiver was previously received. The memory and computer program code may be further configured to, with the processor, cause the apparatus to present the liability waiver for acceptance by the user in an instance in which it is determined that the indication of acceptance of the liability waiver is absent.

In other embodiments, a method and a computer program product are described for enabling use of an application by determining an operating condition of a device; determining a safety rating of an application executed by the device based on the operating condition determined; providing for presentation to a user of a liability waiver regarding use of the application based on the safety rating determined; and providing for storage of an indication of acceptance of the liability waiver and enabling use of the application in an instance in which the indication of acceptance is received. In some cases, at least a portion of functionality of the application may be disabled in an instance in which the indication of acceptance of the liability waiver is absent.

The method and computer program product may receive user identification information. The user identification information may be associated with a corresponding indication of acceptance of the liability waiver, and storage of the user identification information may be provided for. Moreover, in some cases, information may be received relating to use of the application under the operating condition determined. The information relating to use of the application may be associated with the indication of acceptance of the liability waiver and stored. In some embodiments, providing for presentation to the user of the liability waiver may comprise determining whether an indication of acceptance of the liability waiver was previously received and presenting the liability waiver for acceptance by the user in an instance in which it is determined that the indication of acceptance of the liability waiver is absent.

In still other embodiments, an apparatus is described for enabling use of an application. The apparatus may include means for determining an operating condition of a device; means for determining a safety rating of an application executed by the device based on the operating condition determined; means for providing for presentation to a user of a liability waiver regarding use of the application based on the safety rating determined; and means for providing for storage of an indication of acceptance of the liability waiver and enabling use of the application in an instance in which the indication of acceptance is received.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for enabling use of an application based on a determined operating condition and safety rating according to an example embodiment of the present invention;

FIG. 3 illustrates a schematic block diagram of communication among an apparatus, a device, an in-vehicle infotainment system, and a remote server according to an example embodiment of the present invention;

FIG. 4 illustrates an operating condition of the application according to an example embodiment of the present invention;

FIG. 5 illustrates another operating condition of the application according to an example embodiment of the present invention; and

FIG. 6 illustrates a flowchart of a method of enabling use of an application based on a determined operating condition and safety rating according to an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As noted above, users have grown accustomed to having their mobile terminals (e.g., user devices such as portable digital assistants (PDAs) or cellular telephones) at their disposal at all times. In fact, many users interact with their devices while engaged in other activities, such as walking, running, sitting in a vehicle, or driving a vehicle.

In some cases, depending on the activity the user is engaged in, the desired interaction may not put the user in any increased risk of harm. For example, if the user is a passenger on a bus, typing in a text message on the user device would not typically be considered an unsafe activity. If, on the other hand, the user is driving a car and, at the same time, typing or reading a text message, the user's interaction with the user device may distract the user and may cause the user to make an error in judgment while driving, putting the user and those around him at risk.

At the same time, certain types of interactions with the user device may be considered “safer” than others under certain operating conditions. For example, although it may be considered unsafe to manually dial a telephone number on a user device to place a phone call while driving a vehicle (e.g., by using a keypad or by making selections from a touch screen display), providing a voice command to the user device to dial a certain number may be considered just as safe as conducting a conversation with a passenger in the vehicle. Thus, the level of risk associated with providing a voice command, although higher than avoiding interaction with the user device all together, may be lower than other types of interactions with the device that would require more of the user's attention.

In some cases, a user may be willing to accept a certain amount of risk in exchange for the ability to invoke certain functions of the user device. For example, the user may want to operate a music player of the user device to listen to songs while driving to work. The user may recognize that there could be some risk in interacting with the user device to open the music player application and select a particular soundtrack, but may choose to undertake these activities regardless of the risk (for example, attempting to decrease the risk by waiting until the user is stopped at a red light). At the same time, a manufacturer of the user device typically would not want to be subjected to liability in the event the user has poor judgment and decides to interact with the user device in a distracting manner while, for example, driving at 65 mph in a high traffic stretch of highway.

Accordingly, embodiments of the present invention provide for an apparatus that can determine the operating condition of a device and determine a safety rating of an application executed by the device based on the operating condition that is determined. The apparatus may then cause a liability waiver regarding use of the application to be presented to the user for consideration and acceptance based on the safety rating that is determined (e.g., via a vehicle's in-vehicle infotainment (IVI) display). If the user accepts the liability waiver (e.g., agreeing not to hold the manufacturer of the device and/or application liable for harm resulting from interactions with the device and/or application), the apparatus may further provide for the storage of an indication of acceptance of the liability waiver and, in turn, enable use of the application. In cases in which the user does not agree to the liability waiver, however, the apparatus may disable at least a portion of the functionality of the application and/or the device, as described in greater detail below.

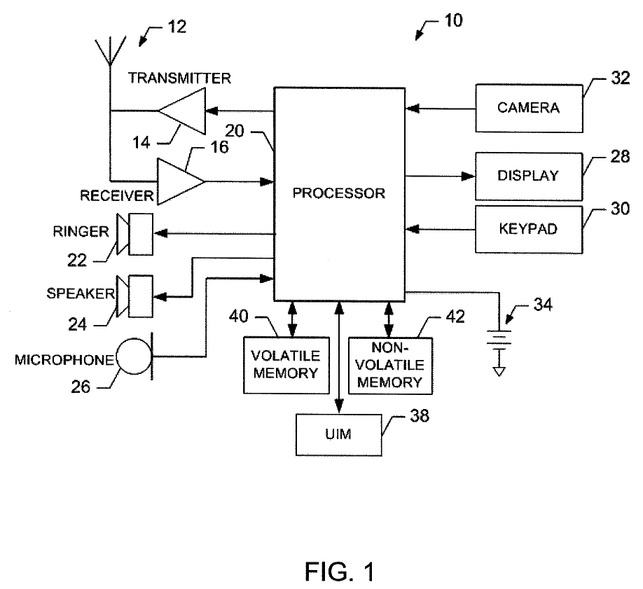

FIG. 1, which provides one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

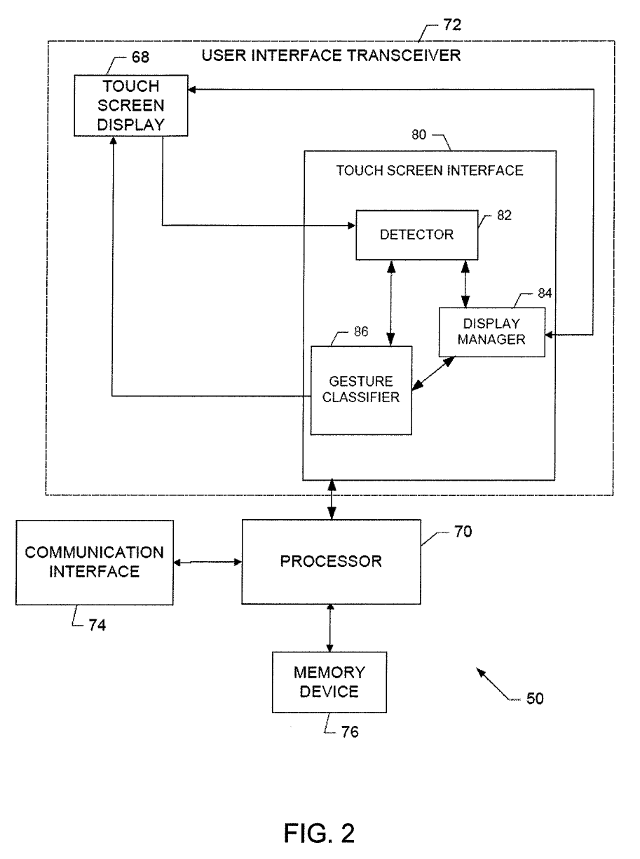

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include a proximity component and/or an orientation component, as described below. The signals may further include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element 32 in order to capture images or video of objects, people, and places proximate to the user of the mobile terminal 10. The mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 2, which depicts certain elements of an apparatus 50 for determining an operating condition of a device and a safety rating of an application executed by the device and for allowing use of the application based in part on the determinations. The apparatus 50 of FIG. 2 may be employed, for example, in conjunction with the mobile terminal 10 of FIG. 1. However, it should be noted that the apparatus 50 of FIG. 2 may also be employed in connection with a variety of other devices, both mobile and fixed, and therefore, embodiments of the present invention should not be limited to devices such as the mobile terminal 10 of FIG. 1. For example, the apparatus 50 may be employed on a personal computer, a tablet, a mobile telephone, or other user terminal. Moreover, in some cases, the apparatus 50 may be on a fixed device such as a server or other service platform and the content may be presented (e.g., via a server/client relationship) on a remote device such as a user terminal (e.g., the mobile terminal 10) based on processing that occurs at the fixed device.

In still other cases, the apparatus 50 may be embodied by an in-vehicle infotainment (IVI) system. IVI systems are integrated in-vehicle entertainment and information systems that provide navigation, entertainment, and networked computing services to passengers in the vehicle. These systems may be installed in cars, trucks, airplanes, and buses and may include features and components such as DVD players, location-based services, external communication functionality (e.g., allowing a user to place a telephone call via the IVI system or sending/receiving data to/from a remote server), and internal connectivity to mobile devices (e.g., connectivity to the user's mobile terminal, such as the user's cellular telephone).

It should be noted that while FIG. 2 illustrates one example of a configuration of an apparatus for allowing use of an application based in part on determinations of an operating condition and a safety rating, numerous other configurations may also be used to implement embodiments of the present invention. As such, in some embodiments, although devices or elements are shown as being in communication with each other, hereinafter such devices or elements should be considered to be capable of being embodied within a same device or element and, thus, devices or elements shown in communication should be understood to alternatively be portions of the same device or element.

Referring now to FIG. 2, the apparatus 50 for allowing use of an application based in part on determinations of an operating condition and safety rating may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

As noted above, the apparatus 50 may, in some embodiments, be a mobile terminal (e.g., mobile terminal 10), an IVI system, or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28), such as a touch screen display of a mobile terminal or a touch screen display mounted to a vehicle dashboard or other vehicle surface. In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, and/or other techniques. The user interface transceiver 72 may be in communication with the touch screen display 68 to receive touch inputs at the touch screen display 68 and to analyze and/or modify a response to such indications based on corresponding user actions that may be inferred or otherwise determined responsive to the touch inputs.

With continued reference to FIG. 2, in an example embodiment, the apparatus 50 may include a touch screen interface 80. The touch screen interface 80 may, in some instances, be a portion of the user interface transceiver 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an input in the form of a touch event at the touch screen display 68. As such, the touch screen interface 80 may be in communication with the touch screen display 68 to receive user inputs at the touch screen display 68 and to modify a response to such inputs based on corresponding user actions that may be inferred or otherwise determined responsive to the inputs. Following recognition of a touch event, the touch screen interface 80 may be configured to determine a classification of the touch event and provide a corresponding function based on the touch event in some situations.

In some embodiments, the touch screen interface 80 may include a detector 82, a display manager 84, and a gesture classifier 86. Each of the detector 82, the display manager 84, and the gesture classifier 86 may be any device or means embodied in either hardware or a combination of hardware and software configured to perform the corresponding functions associated with the detector 82, the display manager 84, and the gesture classifier 86, respectively, as described herein. In an exemplary embodiment, each of the detector 82, the display manager 84, and the gesture classifier 86 may be controlled by or otherwise embodied as the processor 70.

The detector 82 may be in communication with the touch screen display 68 to receive user inputs in order to recognize and/or determine a touch event based on each input received at the detector 82. A touch event may be defined as a detection of an object, such as a stylus, finger, pen, pencil, cellular telephone, digital camera, or any other mobile device (including the mobile terminal 10 shown in FIG. 1) or object, coming into contact with a portion of the touch screen display in a manner sufficient to register as a touch. In this regard, for example, a touch event could be a detection of pressure on the screen of the touch screen display 68 above a particular pressure threshold over a given area. Subsequent to each touch event, the detector 82 may be further configured to pass along the data corresponding to the touch event (e.g., location of touch, length of touch, number of objects touching, touch pressure, touch area, speed of movement, direction of movement, length of delay, frequency of touch, etc.) to the gesture classifier 86 for gesture classification. As such, the detector 82 may include or be in communication with one or more force sensors configured to measure the amount of touch pressure (e.g., force over a given area) applied as a result of a touch event, as an example.

The gesture classifier 86 may be configured to recognize and/or determine a corresponding classification of a touch event. In other words, the gesture classifier 86 may be configured to perform gesture classification to classify the touch event as any of a number of possible gestures. Some examples of recognizable gestures may include a touch, multi-touch, stroke, character, symbol, shape, pinch event (e.g., a pinch in or pinch out), and/or the like.

A touch may be defined as a touch event that impacts a single area (without or with minimal movement on the surface of the touch screen display 68) and then is removed. A multi-touch may be defined as multiple touch events sensed concurrently (or nearly concurrently). A stroke may be defined as a touch event followed immediately by motion of the object initiating the touch event while the object remains in contact with the touch screen display 68. In other words, the stroke may be defined by motion following a touch event thereby forming a continuous, moving touch event defining a moving series of instantaneous touch positions (e.g., as a drag operation or as a flick operation). Examples of a stroke include a “swipe-in” gesture, a “swipe-out” gesture, a “swipe-up” gesture, and a “swipe-down” gesture. Multiple strokes and/or touches may be used to define a particular shape or sequence of shapes to define a character or symbol.

A pinch event may be classified as either a pinch out or a pinch in (hereinafter referred to simply as a pinch). A pinch may be defined as a multi-touch, where the touch events causing the multi-touch are spaced apart. After initial occurrence of the multi-touch event involving at least two objects, one or more of the objects may move substantially toward each other to simulate a pinch. Meanwhile, a pinch out may be defined as a multi-touch, where the touch events causing the multi-touch are relatively close together, followed by movement of the objects initiating the multi-touch substantially away from each other. In some cases, the objects on a pinch out may be so close together initially that they may be interpreted as a single touch, rather than a multi-touch, which then is modified by movement of two objects away from each other.

The gesture classifier 86 may also be configured to communicate detection information regarding the recognition, detection, and/or classification of a touch event to the display manager 84. The display manager 84 may be configured to provide control over modifications made to that which is displayed on the touch screen display 68 based on the detection information received from the detector 82 and gesture classifications provided by the gesture classifier 86 in accordance with the responses prescribed for each respective gesture classification and implementation characteristic determined by the gesture classifier 86. In other words, the display manager 84 may configure the display (e.g., with respect to the content displayed and/or the user interface effects presented relative to the content displayed) according to the gesture classification and implementation characteristic classification determined for a given touch event that may be detected at the display.

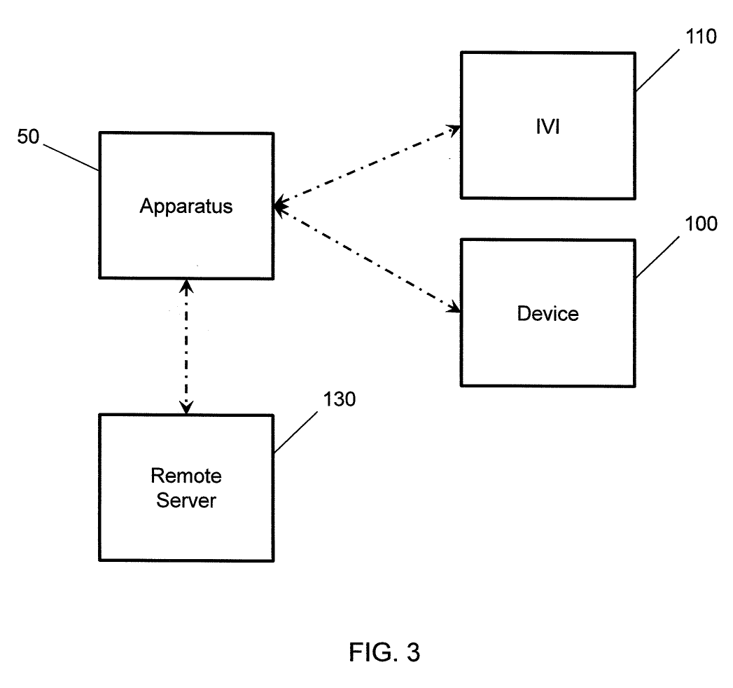

Turning now to FIG. 3, in general, an apparatus 50 is provided, such as an apparatus embodied by the mobile terminal 10 of FIG. 1 (e.g., a cellular phone) or an IVI that has or is otherwise associated with a touch screen display 68. As described above, the apparatus 50 may comprise at least one processor (e.g., processor 70 of FIG. 2) and at least one memory (e.g., memory device 76 of FIG. 2) including computer program code. The at least one memory and the computer program code may be configured to, with the processor, cause the apparatus 50 to at least determine an operating condition of a device 100, such as a user's cellular phone, and to determine a safety rating of an application executed by the device based on the operating condition determined. In some cases, as mentioned above, the apparatus 50 may be embodied by the device 100, such as when the apparatus is embodied by a mobile terminal, and the mobile terminal is the user device that is executing the application.

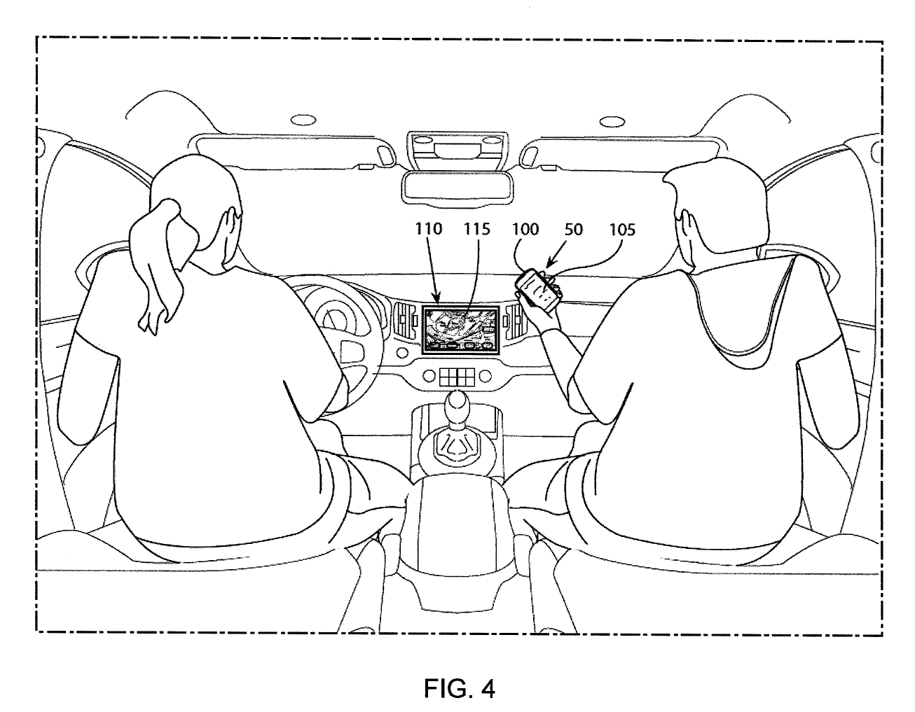

In this regard, the operating condition of the device may be a description of the circumstances surrounding use of the device. For example, the operating condition may include information such as a location of the device 100 with respect to a geographic location or another device (for example, the device's proximity to an IVI system 110, which may indicate that the device is in a vehicle) or a relative motion of the device 100 with respect to a fixed geographic coordinate (which may indicate that the device is in a vehicle traveling on a roadway). Referring to FIG. 4, for example, in which the apparatus 50 is embodied by a device 100 (e.g., a cellular telephone) operated by a user who is a passenger in a vehicle, the apparatus may determine the operating condition of the device 100 by communicating with the vehicle's IVI system 110 to obtain information regarding the device's proximity to the IVI system, the device's relative position with respect to the IVI (e.g., to the right of the IVI, indicating use by a front seat passenger), geographic location of the vehicle, current speed of the vehicle, and so on. Based on this information, the apparatus 50 may be caused to determine that the operating condition of the device 100 is, for example, use in a moving vehicle by a non-driver. In some cases, the operating condition may be received via direct input by the user, such as when the user is asked to select a mode of operation (e.g., driving mode or non-driving mode).

Regardless, in some embodiments, the operating condition of the device, once determined, may be presented to the user as text or as an icon on a display such as the display 105 of the device 100 or the display 115 of the IVI 100. The user may thus be able to confirm that the correct operating condition was determined and/or to make corrections if necessary. Additional information may also be presented on one or both displays 105, 115, such as information regarding whether a particular application is suitable for use by a driver, which may provide the user with an additional level of awareness for making a decision about the suitability of using the application under a given operating condition.

Continuing with the scenario depicted in FIG. 4, the user (e.g., the front seat passenger) may wish to access a text messaging application executed by the device 100. The text messaging application may be associated with a predetermined safety threshold, which may be embedded in the application's software, included in metadata, or otherwise accessible (e.g., via communication with a remote server). The predetermined safety threshold may in turn be an indication of how safe it is for a user to interact with the device to invoke functionality associated with the application under different operating conditions based on the type of user interaction typically required during execution of the application (e.g., how much of the user's attention is required, whether the user must look at or physically interact with the device while providing inputs, how many inputs are typically required/provided, etc.). For example, for a text messaging application, the predetermined safety threshold may indicate that the application is safe to use when the user is not a driver of the vehicle and is unconditionally unsafe to use when the user is a driver of the vehicle. Thus, based on the operating condition that is determined (e.g., in this case, operation by a non-driver within a vehicle), a safety rating of the application may be determined that takes into account the predetermined safety threshold. In this example, because the user is a non-driver and the predetermined safety threshold indicates that the application is safe to use when the user is not the driver, a safety rating of “safe” may be determined.

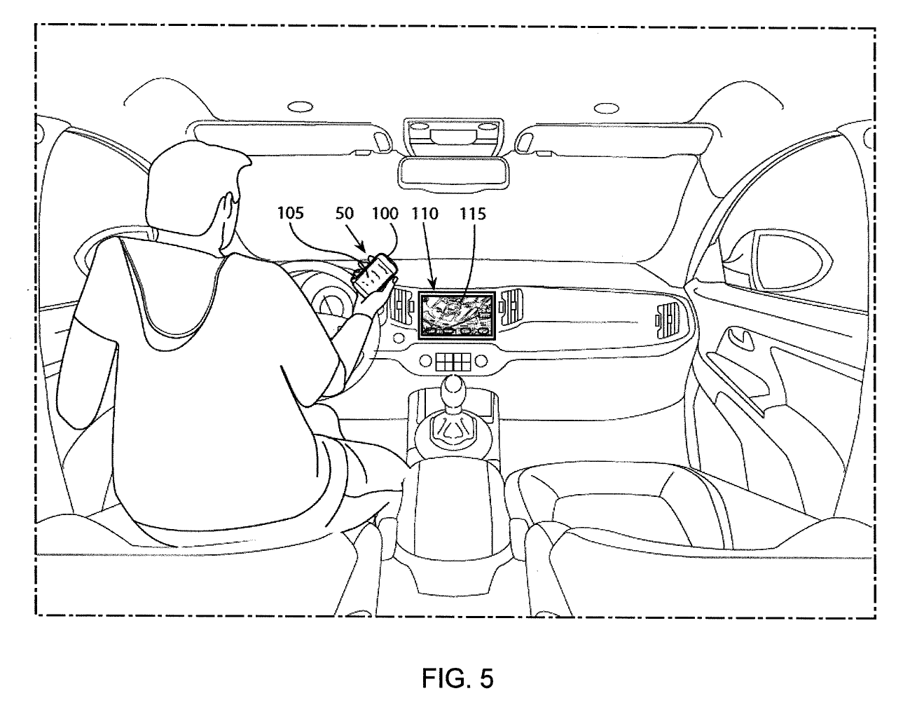

Considering another example, depicted in FIG. 5, the driver of the vehicle may wish to access a telephone application executed by the device 100 while driving the vehicle. The telephone application may be associated with a predetermined safety threshold that indicates that the application is safe to use when the user is not a driver of the vehicle and is conditionally safe to use when the user is a driver of the vehicle. In other words, when the user is a driver of the vehicle as in this example, the user may still be allowed to use the application in certain circumstances, such as when the user agrees to abide by certain terms of use. Thus, in this case, the safety rating of the application may be determined to be “conditionally safe” based on the operating condition determined.

Accordingly, the at least one memory and the computer program code may be configured to, with the processor, cause the apparatus to provide for presentation to the user of a liability waiver regarding use of the application based on the safety rating that is determined. Different liability waivers may be presented depending on the particular application that is requested and/or the operating condition that is determined. The liability waiver may alert the user to the risks involved with accessing and interacting with the requested application and may require the user to agree to release the application or device manufacturer from liability in the event an accident occurs while the application is being used. The liability waiver may further dictate certain terms of use that the user is required to accept. For example, the liability waiver may state that the user agrees not to exceed a certain speed limit or to discontinue use of the application in the event of inclement weather or after sunset.

The liability waiver may be presented to the user on a display 105 of the device 100 or on a display 115 of the IVI system 110. In some cases, the content presented on the display 105 of the device 100 may be communicated to the IVI 110 for presentation on the display 115 of the IVI instead of or in addition to being displayed on the display of the device, e.g., via the apparatus 50. The user may be required to stop the vehicle to read the liability waiver, and an indication of the user's acceptance (e.g., via selection of an “Accept” option presented on the display 105, 115) may be received via the user's interaction with the respective display.

The apparatus 50 may be further caused to provide for storage of an indication of acceptance of the liability waiver and to enable use of the application in an instance in which the indication of acceptance is received. For example, with reference to FIG. 3, the apparatus 50 may be configured to communicate with a remote server 130 and to transmit the indication of acceptance to the server for storage in a memory of or accessible to the server. Once the indication of acceptance is received, the apparatus 50 may enable certain functionality of the application to be used. In the example of FIG. 5, in which the driver desires to access a telephone application, some, if not all, of the functionality of the telephone application may be enabled, such that the user is allowed to place and receive telephone calls, access contact information, listen to voice messages, etc. In some cases, receipt of the indication of acceptance may trigger the enablement of only certain functionality of the desired application, which may be noted in the liability waiver. For example, the user may not be able to use touch inputs to enter a telephone number or select a particular contact to call, but rather may only be able to provide voice commands to invoke the same functions.

In some embodiments, the at least one memory and the computer program code may be configured to, with the processor, cause the apparatus 50 to disable at least a portion of functionality of the application in an instance in which the indication of acceptance of the liability waiver is absent. For example, in a case where the user does not select an “Accept” button to accept the liability waiver presented on the screen or affirmatively selects a “Decline” option, some or all of the functionality of the application may be disabled or suspended. In the case of a telephone application, only voice commands may be accepted as inputs in some cases where the user declines to agree to the liability waiver, or the user may only be allowed to receive in-coming calls, rather than place out-going calls. In this way, the user may be provided with as much functionality of the application as possible without placing undue or unacceptable risk on the user or the device/application manufacturer. As noted above with respect to the indication of acceptance, an indication of non-acceptance may also be stored in a memory.

Depending on the application and/or the configuration of the device 100, in some cases, the liability waiver may require a one-time acceptance, a one-use acceptance, or a one-operating condition acceptance. For example, once the user has provided an indication of acceptance for the use of a particular application, the apparatus may be configured to enable use of the application for the entire time that the application resides on the device or for the entire time the device is associated with a specific user's account or profile. Thus, on a subsequent road trip, the user may not be asked to indicate a second acceptance of the liability waiver in order to gain access to the desired functionality of the device, but may be automatically granted access based on the original acceptance of the liability waiver.

Accordingly, in some cases, the memory and computer program code may be configured to, with the processor, cause the apparatus to determine whether an indication of acceptance of the liability waiver was previously received and to present the liability waiver for acceptance by the user in an instance in which it is determined that the indication of acceptance of the liability waiver is absent. In other cases, however, the apparatus may be caused to present the liability waiver for the user's execution regardless of the existence of past executed liability waivers, such as when the liability waiver is considered a one-use waiver (e.g., when an accepted liability waiver is required for each use of the application under certain operating conditions) or only the first time an application is invoked under a particular operating condition, such as when the liability waiver is considered a one-operating condition waiver.

In some embodiments, the apparatus may be caused to receive information about the user, the usage of the device, or other environmental factors and may provide for the storage of this information along with the indication of acceptance for the application and/or the particular use of the application. This information may subsequently be retrieved and analyzed, for example in the event of a vehicle accident, to determine to what extent, if any, usage of the device and/or interaction with the application contributed to the accident. The user's consent to the collection and storage of such information may be obtained via the indication of acceptance of the liability waiver in some cases. For example, the liability waiver may condition enablement of the functionality of the desired application upon receipt of the user's consent to the collection and storage of such information, and the user's acceptance of the liability waiver may thus be an acceptance of this condition.

Accordingly, in some embodiments, the at least one memory and the computer program code may be configured to, with the processor, cause the apparatus 50 to receive user identification information, such as the user's name, account information relating to the user, authentication information (e.g., a passcode), a captured image of the user (e.g., using a camera of the device 100), biometric information, or other information that identifies the user and associates the use of the application with the particular user. In some cases, the identification information may reflect the user associated with the device 100 (regardless of who is actually interacting with the device at the moment), whereas in other cases the identification information may reflect the actual user invoking a particular application and interacting with the device.

The apparatus 50 may further be caused to associate the user identification information with a corresponding indication of acceptance of the liability waiver and to provide for storage of the user identification information, such as on a memory of the apparatus, a memory associated with the apparatus (e.g., a memory of the device in a case where the apparatus is embodied by the device), or a memory remote from, but accessible to, the apparatus, such as a memory residing on a remote server (e.g., a central repository). The user identification information may subsequently be accessible to the apparatus or to another device or system, such as when the circumstances surrounding a vehicle accident are investigated.

In still other embodiments, the at least one memory and the computer program code may be configured to, with the processor, cause the apparatus 50 to receive information relating to use of the application under the operating condition that is determined. For example, with reference to FIG. 3, the apparatus 50 may be configured to communicate with the IVI 110 and may receive information from the IVI regarding a speed of the vehicle during usage of the application, a location of the vehicle, the route travelled, traffic conditions (e.g., whether the vehicle was in stop-and-go traffic), external temperature and weather conditions, times and duration of use, and/or any other vehicle information determined or available to the IVI. Alternatively or additionally, the apparatus 50 may be configured to communicate with a remote server 130, e.g., via the Internet, to obtain such information. For example, the apparatus 50 may request traffic information or weather information from the remote server 130 using a location of the vehicle as provided by the IVI 110.

This information may be obtained and/or recorded based on periodicity, frequency, application operation, user interaction with the application, and/or predetermined environmental conditions. For example, the information may be recorded when a predetermined speed is exceeded, when the user applies the brakes more than a predetermined number of times over a given time period, etc. The apparatus may also correlate such environmental or operational information with the user's interaction with the application. For example, the apparatus may record speed or use of the vehicle's brake that occur while a series of user inputs are being received by the application.

As described above with respect to the user identification information, the apparatus 50 may thus be caused to associate the information relating to use of the application with the indication of acceptance of the liability waiver and to store the information relating to use of the application on a memory. Such information may later be accessed to facilitate an investigation of an accident, such as to determine whether the user (if the user was the driver at the time of the accident) was speeding or breached a condition that was stated in the accepted the liability waiver.

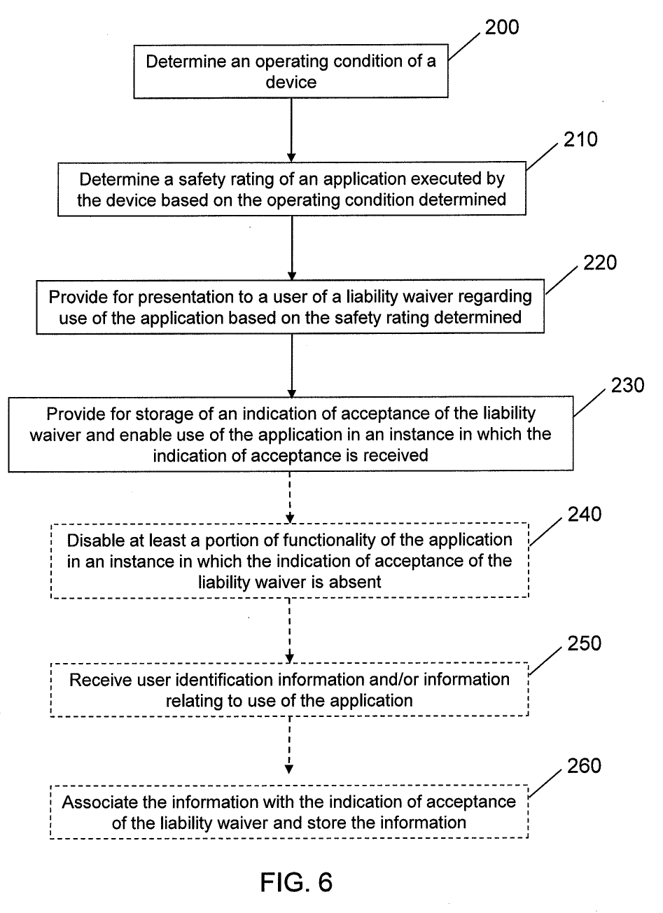

FIG. 6 illustrates a flowchart of systems, methods, and computer program products according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one embodiment of a method for enabling use of an application based on a determined operating condition and safety rating, as shown in FIG. 6, includes determining, via a processor, an operating condition of a device at Block 200; determining, via the processor, a safety rating of an application executed by the device based on the operating condition determined at Block 210; providing for presentation to a user of a liability waiver regarding use of the application based on the safety rating determined at Block 220; and providing for storage of an indication of acceptance of the liability waiver and enabling use of the application in an instance in which the indication of acceptance is received at Block 230, as described above. Moreover, in some embodiments, providing for presentation to the user of the liability waiver may comprise determining whether an indication of acceptance of the liability waiver was previously received and presenting the liability waiver for acceptance by the user in an instance in which it is determined that the indication of acceptance of the liability waiver is absent.

In some cases, the method may further comprise disabling at least a portion of functionality of the application in an instance in which the indication of acceptance of the liability waiver is absent at Block 240. In addition, information, such as user identification information and information relating to use of the application, may be received at Block 250, and this information may be associated with the indication of acceptance of the liability waiver and stored at Block 260, as described above.

In some embodiments, certain ones of the operations above may be modified or further amplified as described below. Furthermore, in some embodiments, additional optional operations may be included, some examples of which are shown in dashed lines in FIG. 6. Modifications, additions, or amplifications to the operations above may be performed in any order and in any combination.

In an example embodiment, an apparatus for performing the method of FIG. 6 above may comprise a processor (e.g., the processor 70 of FIG. 2) configured to perform some or each of the operations (200-260) described above. The processor may, for example, be configured to perform the operations (200-260) by performing hardware implemented logical functions, executing stored instructions, or executing algorithms for performing each of the operations. Alternatively, the apparatus may comprise means for performing each of the operations described above. In this regard, according to an example embodiment, examples of means for performing at least portions of operations 200, 220, 230, and 250 may comprise, for example, the communication interface 74, the user interface transceiver 72, the processor 70, the memory device 76, and/or a device or circuit for executing instructions or executing an algorithm for processing information as described above. Examples of means for performing operation 210, 240, and 260 may comprise, for example, the communication interface 74, the processor 70, the memory device 76, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
determine an operating condition of a device;
determine a safety rating of an application executed by the device based on the operating condition determined;
provide for presentation to a user of a liability waiver regarding use of the application based on the safety rating determined; and
provide for storage of an indication of acceptance of the liability waiver and enable use of the application in an instance in which the indication of acceptance is received.

2. The apparatus of claim 1, wherein the memory and computer program code are configured to, with the processor, cause the apparatus to disable at least a portion of functionality of the application in an instance in which the indication of acceptance of the liability waiver is absent.

3. The apparatus of claim 1, wherein the memory and computer program code are configured to, with the processor, cause the apparatus to receive user identification information.

4. The apparatus of claim 3, wherein the memory and computer program code are configured to, with the processor, cause the apparatus to associate the user identification information with a corresponding indication of acceptance of the liability waiver and to provide for storage of the user identification information.

5. The apparatus of claim 1, wherein the memory and computer program code are configured to, with the processor, cause the apparatus to receive information relating to use of the application under the operating condition determined.

6. The apparatus of claim 5, wherein the memory and computer program code are configured to, with the processor, cause the apparatus to associate the information relating to use of the application with the indication of acceptance of the liability waiver and to store the information relating to use of the application.

7. The apparatus of claim 1, wherein the memory and computer program code are configured to, with the processor, cause the apparatus to determine whether an indication of acceptance of the liability waiver was previously received, and wherein the memory and computer program code are further configured to, with the processor, cause the apparatus to present the liability waiver for acceptance by the user in an instance in which it is determined that the indication of acceptance of the liability waiver is absent.

8. A method comprising:
determining, via a processor, an operating condition of a device;
determining, via the processor, a safety rating of an application executed by the device based on the operating condition determined;
providing for presentation to a user of a liability waiver regarding use of the application based on the safety rating determined; and
providing for storage of an indication of acceptance of the liability waiver and enabling use of the application in an instance in which the indication of acceptance is received.

9. The method of claim 8 further comprising disabling at least a portion of functionality of the application in an instance in which the indication of acceptance of the liability waiver is absent.

10. The method of claim 8 further comprising receiving user identification information.

11. The method of claim 10 further comprising associating the user identification information with a corresponding indication of acceptance of the liability waiver and providing for storage of the user identification information.

12. The method of claim 8 further comprising receiving information relating to use of the application under the operating condition determined, associating the information relating to use of the application with the indication of acceptance of the liability waiver, and storing the information relating to use of the application.

13. The method of claim 8, wherein providing for presentation to the user of the liability waiver comprises determining whether an indication of acceptance of the liability waiver was previously received and presenting the liability waiver for acceptance by the user in an instance in which it is determined that the indication of acceptance of the liability waiver is absent.

14. A computer program product comprising at least one computer-readable storage medium having computer-executable program code portions stored therein, the computer-executable program code portions comprising program code instructions for:
determining an operating condition of a device;
determining a safety rating of an application executed by the device based on the operating condition determined;
providing for presentation to a user of a liability waiver regarding use of the application based on the safety rating determined; and
providing for storage of an indication of acceptance of the liability waiver and enabling use of the application in an instance in which the indication of acceptance is received.

15. The computer program product of claim 14 further comprising program code instructions for disabling at least a portion of functionality of the application in an instance in which the indication of acceptance of the liability waiver is absent.

16. The computer program product of claim 14 further comprising program code instructions for receiving user identification information.

17. The computer program product of claim 16 further comprising program code instructions for associating the user identification information with a corresponding indication of acceptance of the liability waiver and providing for storage of the user identification information.

18. The computer program product of claim 14 further comprising program code instructions for receiving information relating to use of the application under the operating condition determined.

19. The computer program product of claim 14 further comprising program code instructions for associating the information relating to use of the application with the indication of acceptance of the liability waiver and storing the information relating to use of the application.

20. The computer program product of claim 14 further comprising program code instructions for determining whether an indication of acceptance of the liability waiver was previously received and presenting the liability waiver for acceptance by the user in an instance in which it is determined that the indication of acceptance of the liability waiver is absent.
